(19) United States
(12) Patent Application Publication
(10) Pub. No.: US 2016/0061329 A1
(43) Pub. Date: Mar. 3, 2016

(54) MECHANICAL SEAL FITTING SYSTEM AND METHOD

(71) Applicant: Larry Herbrich, La Grange, TX (US)

(72) Inventor: Larry Herbrich, La Grange, TX (US)

(21) Appl. No.: 14/474,937

(22) Filed: Sep. 2, 2014

(51) Int. Cl. F16J 15/32; C10M 107/38; C10M 101/02; B25B 27/00

(52) U.S. Cl. CPC F16J 15/3204; B25B 27/0028; C10M 107/38; C10M 101/02

(57) ABSTRACT

A method of installing a mechanical seal includes wrapping a sleeve around a shaft, placing the seal over the wrapped sleeve and shaft, sliding the seal along the wrapped sleeve and shaft, toward a housing, and pressing the seal into seat in the housing. The sleeve has dimensions of length at least about same as length of the shaft protruding from the housing and width at least greater than the circumference of the shaft. Thickness of the sleeve ranges from about 0.01 inches (0.254 mm) to about 0.05 inches (1.27 mm). The sleeve is formed of polyethylene terephthalate, low-density polyethylene, polyvinyl chloride, high-density polyethylene, other elastomer, other polymer, or combinations of these. The sleeve may include a lubricant.

### TECHNICAL FIELD

The invention generally relates to fitting mechanical seals, and more particularly relates to seal installation systems and methods for fitting a tight seal to a shaft and housing without damage to the seal.

### BACKGROUND

Mechanical seals are employed to retain a tight fit to prevent fluid leakage, contain pressure, or exclude contamination. The seals must tightly snug to any shaft and housing to which installed. These seals are typically rubber, polymer, composite, or similar composition. As examples, gear box, strut, hydraulic pump, shredder, combine, tractor, automotive, axle, valve stem, oil field and other equipment must be sealed by seals. Damage or deformation of the seals can lead to malfunction of the seal and damage or failure of operation of the equipment.

A common application of a seal is with mechanical fixtures which house a protruding drive shaft or the like. One non-exclusive example of this type of mechanical seal is a radial shaft seal (also known as a lip seal). The radial shaft seal is used to seal rotary elements, such as a shaft or rotating bore protruding from a housing. The seal must fit tightly against the housing and the shaft, yet permit the shaft to rotate against the seal.

As may be expected, mechanical seals, including radial shaft seals, wear in use and become less effective for sealing over time. Seals may also degrade due to exposures to oils, chemicals or other application impacts, as well as environmental (heat, cold, etc.) and other adverse exposures. In the case of seals (e.g., such as radial shaft seals) which snug against moving mechanical elements, abrasion and wear can result from mechanical movements. Seals must consequently be periodically replaced.

Installation (including replacement installation) of seals has been problematic. The typically tight fit of the seal makes installation/replacement operations physically difficult to perform. Beyond the efforts that may be required to access the seal, an old seal must be accessed and removed, and a new seal installed with tight fit. This has been time-consuming and labor intensive.

Further, seals may become damaged or deformed during manipulation in the installation/replacement operation. This is particularly the case with seals for shafts, such as radial shaft seals. The shaft often has splines or sharp edges along the shaft or on shoulders of the shaft. Because the seal is sized and configured to tightly fit against the shaft and housing, the seal must typically be forced over and on the splines and edges and along the shaft into sealing placement. These splines and edges can cut or abrade the surface of the seal during installation/replacement.

Moreover, shafts often require shim stock materials placed around the shaft to allow the seal to travel along the shaft during installation. These shim stock materials can also have sharp edges which damage the seal. The mechanic, therefore, may be required to purchase and carry the shim stock materials for each different shaft to suit varied occasions of installation/replacement of seals.

Further still, conventional seals often require particular chuck or other equipment for installation operations. This equipment is used to support the seal to avoid deformation of the seal (such as lip deformation) as the seal is fitted into place. The equipment can be expensive and is not standardized in size and design. Therefore, different chucks and similar equipment must be purchased and available to successfully install and replace the various seals in each different application.

It would be an improvement to provide improved systems and methods for seal installation and replacement installation (collectively, “installation”). It would further be an improvement to provide systems and methods for installing seals without damage to the seals caused by the installation process. Moreover, it would be an improvement to eliminate the need for shim stock, splines, chucks, and similar equipment in most circumstances of seal installation. It would also be an improvement to provide inexpensive and ready-kept systems and methods for installing seals.

### SUMMARY

An embodiment of the invention is a system for installing a seal on a shaft. The system includes a sleeve wrappable around the shaft, the sleeve is sufficiently strong to avoid tear and configured to guide the seal into position along the shaft.

Another embodiment of the invention is a system for installing a seal on a shaft. The system includes a sheet of sleeve material. The sheet has dimensions of length at least about same as length of the extended shaft and width at least greater than the circumference of the shaft. The sheet has thickness in the range of about 0.01 inches (0.254 mm) to about 0.05 inches (1.27 mm). The sheet is formed of a material selected from polyethylene terephthalate, low-density polyethylene, polyvinyl chloride, high-density polyethylene, other elastomer, other polymer, or combinations of these.

Yet another embodiment of the invention is a system for installing a seal on a shaft. The system includes a roll of sleeve material. The tape of the roll has dimensions of length at least about same as length of the extended shaft and width at least greater than the circumference of the shaft, and has thickness in the range of about 0.01 inches (0.254 mm) to about 0.05 inches (1.27 mm). The tape of the roll is formed of polyethylene terephthalate, low-density polyethylene, polyvinyl chloride, high-density polyethylene, other elastomer, other polymer, or combinations of these.

Another embodiment of the invention is a method of installing a seal on a protruding shaft and seated in a housing. The method includes wrapping a sleeve around the shaft, placing the seal over the wrapped sleeve and shaft, sliding the seal along the wrapped sleeve and shaft, toward the housing, and pressing the seal into seat in the housing.

Yet another embodiment of the invention is the installed seal produced according to the method.

### BRIEF DESCRIPTION OF THE DRAWINGS

The present invention is illustrated by way of example and not limitation in the accompanying figures, in which like references indicate similar elements, and in which:

FIG. 1 illustrates a seal and a shaft and housing to which the seal is for installation, according to certain embodiments;

FIG. 2 illustrates a mechanical seal sprung along a shaft-sealing lip, according to certain embodiments;

FIG. 3 illustrates a sleeve for installing a mechanical seal, according to certain embodiments;

FIG. 4 illustrates a sheet of sleeve material, according to certain embodiments;

FIG. 5 illustrates a tape roll of sleeve material, according to certain embodiments;

FIG. 6 illustrates a sleeve for installing a mechanical seal, the sleeve is wrapped around a shaft protruding from a housing, according to certain embodiments;

FIG. 7 illustrates a sleeve wrapped around a shaft protruding from a housing, for installing a mechanical seal to seal the shaft and housing, according to certain embodiments;

FIG. 8 illustrates a seal installed to seal a shaft and housing, using a sleeve which is being removed from wrap around the shaft, according to certain embodiments; and

FIG. 9 illustrates a method of installing a seal using a sleeve, according to certain embodiments.

### DETAILED DESCRIPTION

The following description refers to certain specific embodiments; however, the specific embodiments are merely illustrative and variations and changes may be made in the embodiments without diverting from the broad scope encompassed by the disclosure.

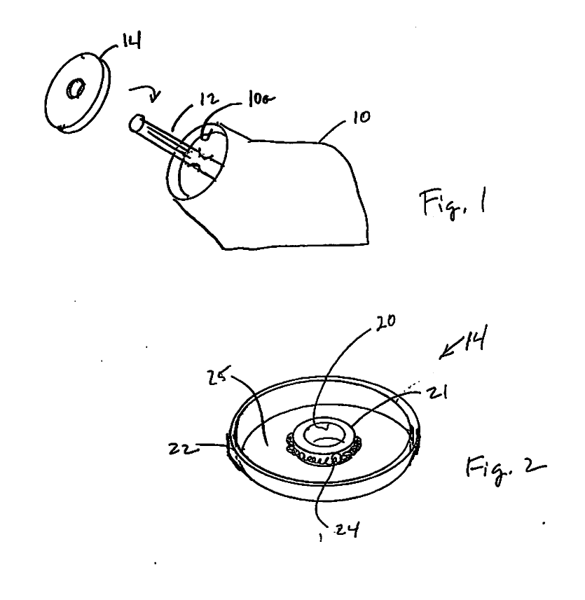

Referring to FIG. 1, a mechanical seal 14 is connected to a housing 10 and protruding shaft 12. The housing 10 may contain gears, levers, bearings and other equipment (not shown in detail in FIG. 1) for rotating, levering, or otherwise manipulating/moving the shaft 12 in relation to the housing 10. The mechanical seal 14 tightly snugs the housing 10 and the shaft 12 to prevent leakage, contamination, or other effects to the contents of the housing 10 and the shaft 12.

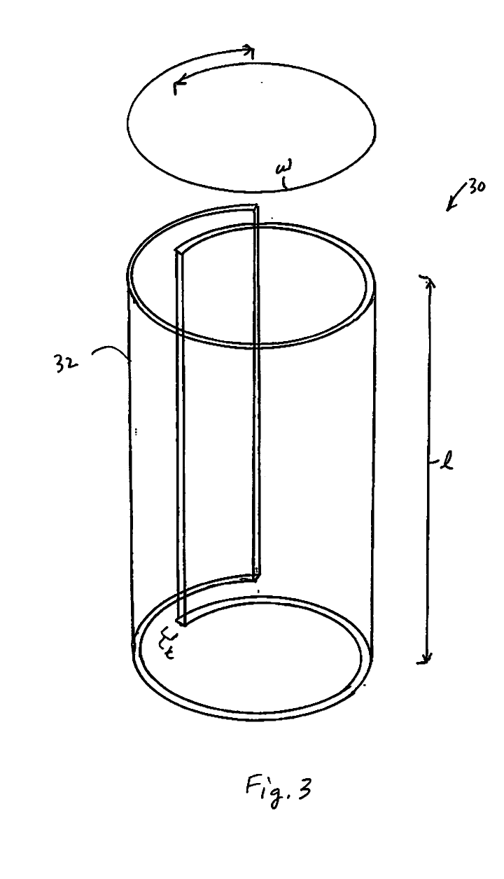

Referring to FIG. 2, in conjunction with FIG. 1, the seal 14, as a non-exclusive example, includes a toroidal plate 25 forming a central annular lip 21 in a middle hole 20 of the plate, and circumferential edge 22 extending perpendicular to the plate 25. The seal 14 is circumferentially sized to tightly fit an opening 10a formed of the housing 10. The central annular lip 21 is sized though the hole 20 to accept and hold the shaft 12 in tight engagement. The lip 21 may, but need not necessarily, be biased, such as by a radial spring 24, towards the hole 20 for tight fit against the shaft 12 in use. The edge 22 may, but need not necessarily, be biased away from the hole 20 for tight fit against the opening 10a of the housing 10 in use.

FIG. 2 shows the underside of a typical type of mechanical seal 14. The seal 14 includes an inner rim through which passes a portal 20 for accommodating passage of the drive shaft 12. The outer rim 22 seals against the housing 10 in use, and the drive shaft is sealed within the portal 20. A spring 24 is usually included surrounding the inner rim 24 in order to provide a tight seal of the portal 20 against the drive shaft 12 as it rotates.

In operation, the seal 14 is fitted on and passed along the shaft 12 via the hole 20, into engagement with the opening 10a of the housing 10. As installed, the seal 14 tightly engages the shaft 12 and the housing 10, to prevent leakage, contamination or otherwise.

Referring to FIG. 3, a system 30 for installation (including replacement installation) of a seal includes a sleeve 32. The sleeve 32 is a sheet extending a length “l”. The length (l) is at least about the same as extent of protrusion of a shaft (e.g., shaft 12) from a housing (e.g., housing 10) in which a seal is to be installed. The sheet of the sleeve 32 extends a width “w” of at least about (and preferably slightly more) than the circumference of the shaft. The sleeve 32 may, but need not necessarily, have a curved bias along the width (w). A curved bias can aid wrapping of the sleeve 32 around the circumference of the shaft as later described.

The thickness “t” of the sleeve 32 is generally about uniform over the entirety, and ranges from on the order of about 0.01 inches (0.254 mm) to about 0.05 inches (1.27 mm), and preferably is about 0.025 inches (0.635 mm) although any suitable thickness for the later described operations is suitable. The thickness (t) of the sleeve must be sufficient to allow manual wrapping of the width (w) of the sleeve 32 around the shaft with the length (l) extending along the shaft, and impart sufficient strength to prevent the sleeve from tear or bunching during seal installation later described.

Suitable materials for the sleeve 32 include, for example, polyethylene terephthalate (PET, also know as PETE), low-density polyethylene (LDPE), polyvinyl chloride (PVC), high-density polyethylene (HDPE) or other elastomeric or polymeric materials. The sleeve 32 may be coated on one or both extended surfaces with a lubricant, such as petroleum jelly, oil, polytetrafluoroethylene (e.g., Teflon®) or other component that reduces friction of the sleeve 32 when the seal is slid engagingly along the surface of the sleeve 32 during seal installation.

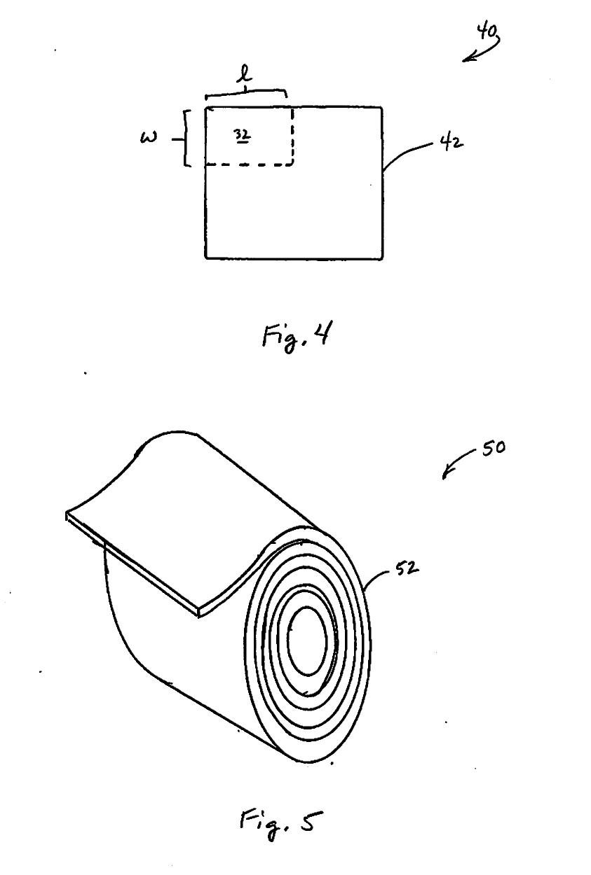

Referring to FIG. 4, in conjunction with FIG. 3, a sleeve sheet 40 includes a flat and oversized width and length (i.e., at least about width (w) and/or about length (l)) of a sheet of sleeve material. The sleeve 32 may be cut or otherwise removed from the sleeve sheet 40, such that the sleeve 32 has desired measurements. The sleeve sheet 40 may be particularly sized to avoid waste of the material, such as sized to the width (w) and/or the length (l). A variety of sheet 40 sizes are possible, and sheets 40 may be selectively sized to avoid waste of sheet material when used to wrap common circumferences of various-sized shafts or otherwise.

Referring to FIG. 5, in conjunction with FIG. 3, a sleeve roll 50 includes a tape 52 of sleeve material. The tape 52 may be sized to have a width of the tape 52 of about width (w) of the sleeve 32 or greater. If the tape 52 is sized of greater than width (w) of the sleeve 32, the sleeve 32 may be cut or otherwise extracted from the tape 52. Pluralities of tapes 52 are possible, with each having different width in various extents for common circumferences of differently-sized shafts or the like.

Referring to FIG. 6, in conjunction with FIGS. 1-3, a system 60 for fitting a mechanical seal 64 employs a gliding/slip sleeve 62. The sleeve 62 is a sheet of plastic or thin material that is wrapped (e.g., curls) around a shaft 66 to be sealed. The seal 64 is place with a central portal 66 surrounding the sleeve 62 curled/wrapped against the shaft 66. The seal 64 slides (via the portal 66) along the sleeve 62 and over and along the shaft 66. The sleeve 62 is sufficiently slippery to allow the seal 64 to slide along the material of the sleeve 62 and is sufficiently stiff to aid passage of the seal 64 over splines, ridges, bumps, irregularities, striations, etc. in the surface of the shaft 66.

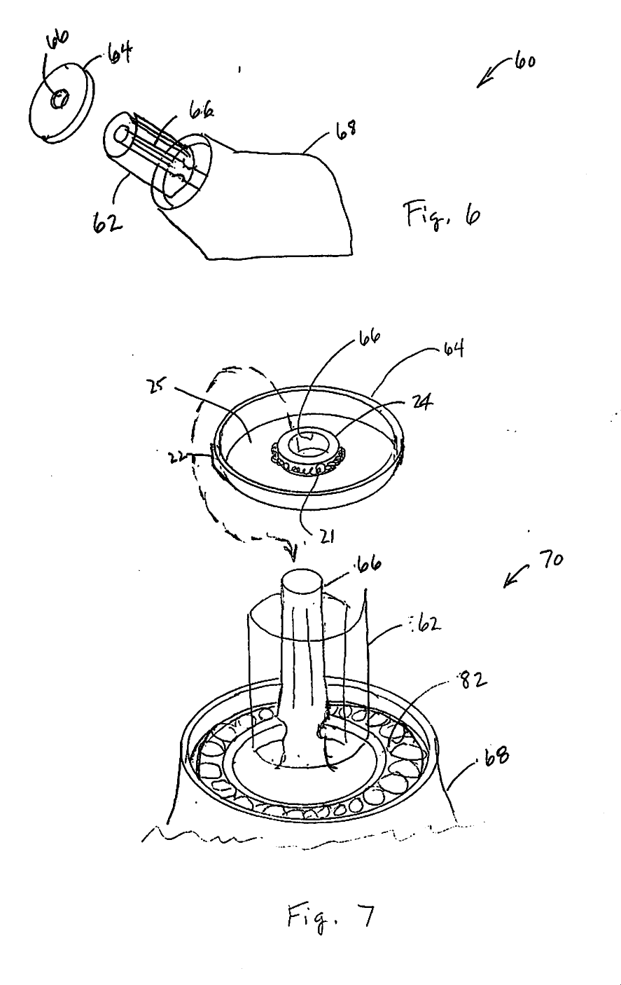

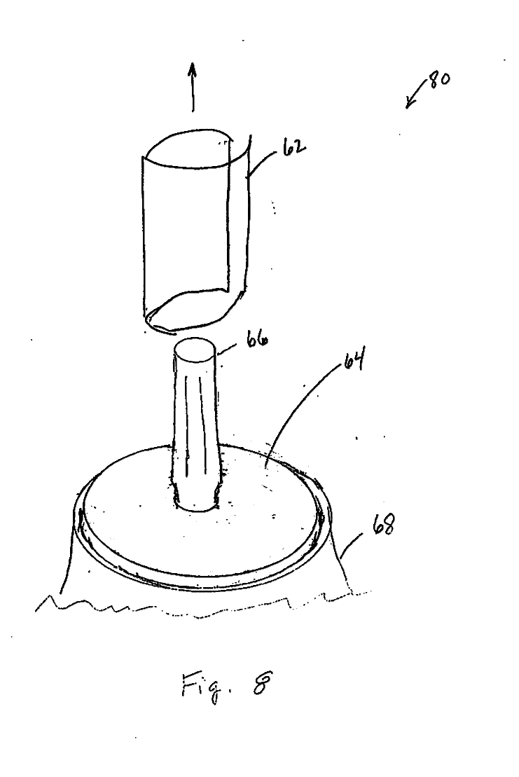

Referring to FIG. 7, in conjunction with FIGS. 2 and 6, the sleeve 62 is wrapped against the shaft 66 (e.g., the sleeve 62 is material that curls to wrap the shaft). An example of the sleeve 62 is a thin sheet of a plastic material, such as, for example, polyethylene terephthalate (PET, also know as PETE), low-density polyethylene (LDPE), polyvinyl chloride (PVC), high-density polyethylene (HDPE) or other elastomeric or polymeric materials. Thickness of the sheet is generally about uniform over entirety of the sheet, and ranges from on the order of about 0.01 inches (0.254 mm) to about 0.05 inches (1.27 mm), and preferably is about 0.025 inches (0.635 mm) although any suitable thickness for the described operations is suitable. The sleeve 62 is sized to wrap (i.e., with overlap of about 1/8″ to about 1″) the shaft 66, and to extend for at least the length of the shaft 66. The sleeve 62 may, but need not necessarily, have a natural curl bias in a direction to aid in wrapping the shaft 66. The sleeve may, but need not necessarily, include a slippery lubricant, for example, petroleum jelly, oil, polytetrafluoroethylene (e.g., Teflon®) or other, on one or both extended surfaces of the sleeve 62. In certain alternatives, such a lubricant may be added to the extended surface(s) of the sleeve 62 either prior to or after wrapping of the sleeve 62 around the shaft 66 and prior to placement of the seal 64.

Once the sleeve 62 is wrapped against the shaft 66, the seal 64 is placed with the portal 66 centered around the shaft 66 wrapped with the sleeve 62. The seal 64 slides via the portal 66 along the sleeve 62, thereby sliding along the shaft 66. The seal 64 is pushed by force into the housing 68 and in position on the shaft 66. The seal 64, for example, encloses the housing 68 that may contain bearings and/or other mechanical structures.

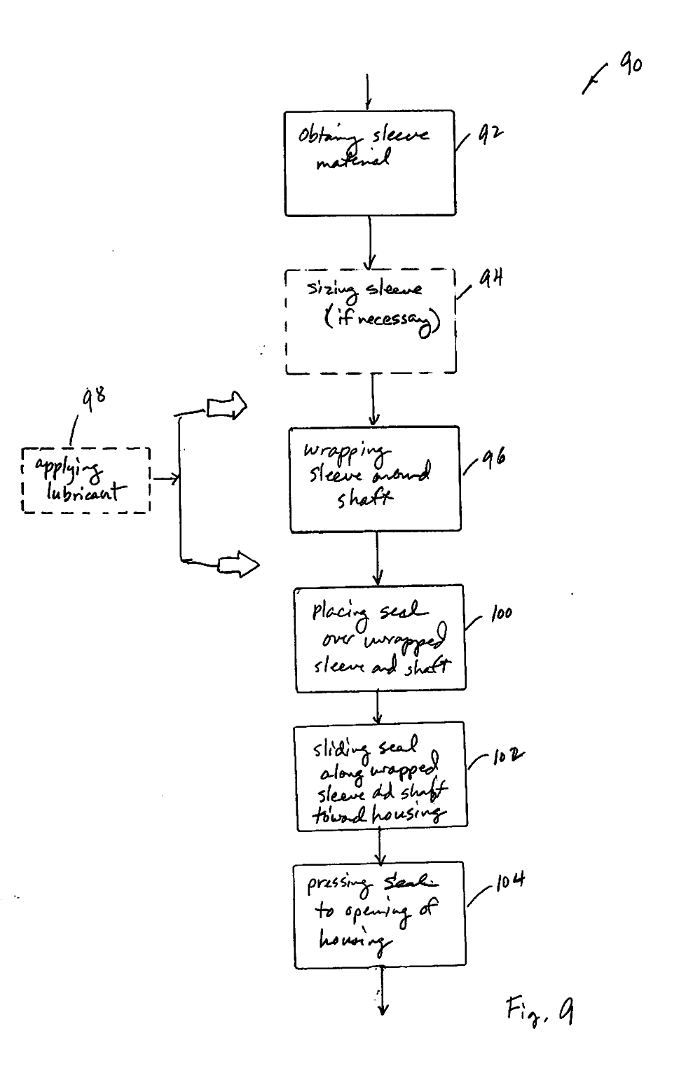

Referring to FIG. 8, in conjunction with FIGS. 6 and 7, the seal 64 is in final operative position on the shaft 66 and mating with the housing 68. Once so positioned, the sleeve 62 is pulled (upward in the Figure) to slide it from the shaft 66. Tools, such as pliers or other, may be helpful to grip the sleeve 62 for pulling it from wedged engagement with the seal 64 and shaft 66. The seal 64 remains in place for operation.

Referring to FIG. 9, a method 90 of installing a seal commences with a step 92 of obtaining a sleeve. The sleeve is, for example, a thin, flexible sheet of a plastic or other sheet material, for example, PET, LDPE, PVC, HDPE or other elastomeric or polymeric materials. The sheet should have a thickness that is generally about uniform, and within the range of on the order of about 0.01 inches (0.254 mm) to about 0.05 inches (1.27 mm), and preferably is about 0.025 inches (0.635 mm) although any other thickness suitable for the method 90 is possible.

A step of sizing 94 the sleeve is performed if the sheet from the step 92 is of greater size than about a length of a shaft on which the seal is to be applied and at least greater than the circumference measure of the shaft. In the step 94, the sheet is sized, for example, by trimming to desirable length and width by scissors, knife, saw, or any other suitable device for cutting, ripping or otherwise trimming the sleeve material. In a non-exclusive embodiment, the sleeve is sized in the step 94 such that the length (l) is at least about the same as extent of protrusion of a shaft from a housing in which a seal is to be installed and that the width (w) is at least about (and preferably slightly more, e.g., 1/8″ to 1″ or greater with larger diameter shafts) than the measure of the circumference of the shaft. As previously mentioned, the sheet of material for the sleeve may, but need not necessarily, have a curved bias along the width, which can aid succeeding steps of the method 90.

In a step of wrapping 96 the sleeve, the sleeve from the step of sizing 94 is wrapped via the width of the sleeve, around the shaft protruding from the housing. The wrapping 96 snugs the sleeve against the longitudinal surface of the shaft, causing overlap of ends of the sleeve, and the length of the sleeve extends along the longitudinal surface from the protruding extent of the shaft to the location for the seal along the shaft on installation.

A step 98 of applying a lubricant to the sleeve may, but need not necessarily, be performed. In certain embodiments, the sheet of sleeve material in the step 92 is pre-coated on one or both extended surfaces, with a lubricant, for example, petroleum jelly, oil, polytetrafluoroethylene (e.g., Teflon®) or other. In certain alternatives, a step 98 is performed either before or after the step 96. In the step 98, the lubricant is applied to one or both extended surfaces of the sleeve. Because the sleeve is wrapped in the step 96 to snug with the shaft, application of lubricant after the step 96 may be limited to the outer surface of the sleeve (i.e., the inner surface may not be easily reached on snug of the sleeve with the shaft).

In a step 100, the seal is placed with a central opening of the seal directed over the wrapped sleeve and onto the shaft. The seal is then slid in a step 102 along the wrapped sleeve and shaft toward the housing. Typically, the housing includes a seat for the seal, and the seal is pressed in a step 104 into an opening of the housing (i.e., settled in the seat).

Once the seal is set in the seat, the wrapped sleeve is pulled from wedged engagement by the seal and shaft. Pliers or other tools may be helpful to grip the sleeve to aid pulling removal.

Numerous variations in the foregoing are possible. Alternative sleeve materials can include any thin sheet-like material that is sufficiently strong to avoid tear and that avoids friction when the seal is slid along the material (and any wrapped shaft or protrusion) to seat the seal. Examples of such materials include metals (e.g., aluminum foils), plastics, rubber, composites, and other thin and sufficiently strong and anti-friction sheets. A variety of lubricants are also possible, for example, water or other liquid or limited viscosity compounds. Sleeve material may be provided pre-coated with lubricant on one or both sides, as desirable. Rolls of sleeve material with pre-coated lubricant (or not) are possible. In certain alternatives, sleeve materials are provided pre-sized for different applications. In other alternatives, sleeves are cut from oversized sheets or rolls of the sleeve material.

In the foregoing, the invention has been described with reference to specific embodiments. One of ordinary skill in the art will appreciate, however, that various modifications, substitutions, deletions, and additions can be made without departing from the scope of the invention. Accordingly, the specification and figures are to be regarded in an illustrative rather than a restrictive sense, and all such modifications substitutions, deletions, and additions are intended to be included within the scope of the invention. Any benefits, advantages, or solutions to problems that may have been described above with regard to specific embodiments, as well as device(s), connection(s), step(s) and element(s) that may cause any benefit, advantage, or solution to occur or become more pronounced, are not to be construed as a critical, required, or essential feature or element.

What is claimed is:

1. A system for installing a seal on a shaft, comprising:
a sleeve wrappable around the shaft, the sleeve is sufficiently strong to avoid tear and configured to guide the seal into position along the shaft.

2. The device of claim 1, wherein the sleeve has dimensions of length at least about same as length of the extended shaft and width at least greater than the circumference of the shaft.

3. The device of claim 1, wherein the sleeve has thickness in the range of about 0.01 inches (0.254 mm) to about 0.05 inches (1.27 mm).

4. The device of claim 3, wherein the sleeve has dimensions of length at least about same as length of the extended shaft and width at least greater than the circumference of the shaft.

5. The device of claim 4, wherein the sleeve is formed of PET.

6. The device of claim 4, further comprising:
a lubricant laminated on the extended surface of the sleeve.

7. The device of claim 6, wherein the lubricant is selected from the group consisting of: petroleum jelly, oil, polytetrafluoroethylene (e.g., Teflon®), and combinations.

8. A system for installing a seal on a shaft, comprising:
a sheet of sleeve material, the sheet has dimensions of length at least about same as length of the extended shaft and width at least greater than the circumference of the shaft, has thickness in the range of about 0.01 inches (0.254 mm) to about 0.05 inches (1.27 mm), and is formed of a material selected from the group of: PET, LDPE, PVC, HDPE, other elastomeric, other polymer, or combinations of these.

9. A system for installing a seal on a shaft, comprising:
a roll of sleeve material, the tape of the roll has dimensions of length at least about same as length of the extended shaft and width at least greater than the circumference of the shaft, has thickness in the range of about 0.01 inches (0.254 mm) to about 0.05 inches (1.27 mm), and is formed of a material selected from the group of: PET, LDPE, PVC, HDPE, other elastomeric, other polymer, or combinations of these.

10. A method of installing a seal on a protruding shaft and seated in a housing, comprising the steps of:
wrapping a sleeve around the shaft;
placing the seal over the wrapped sleeve and shaft;
sliding the seal along the wrapped sleeve and shaft, toward the housing; and
pressing the seal into seat in the housing.

11. The method of claim 10, further comprising the step of:
obtaining a sheet of material for the sleeve; and
sizing the sheet of material for the sleeve.

12. The method of claim 10, further comprising the step of:
applying a lubricant to the sleeve.

13. The method of claim 11, further comprising the step of:
laminating the sleeve with a lubricant.

14. The method of claim 10, further comprising the step of:
obtaining a roll of material for the sleeve; and
sizing tape of the roll of material for the sleeve.

15. The method of claim 14, further comprising the step of:
laminating tape of the roll with a lubricant.

16. An installed seal produced in accordance with the method of claim 10.

17. An installed seal produced in accordance with the method of claim 11.

18. An installed seal produced in accordance with the method of claim 12.

19. An installed seal produced in accordance with the method of claim 14.

20. An installed seal produced in accordance with the method of claim 15.
